(19) United States
(12) Patent Application Publication
(10) Pub. No.: US 2018/0316388 A1
(43) Pub. Date: Nov. 1, 2018

(54) WIRELESS POWER TRANSMITTER, WIRELESS POWER RECEIVER, AND WIRELESS SYSTEM, FOR TRANSMITTING AND RECEIVING WIRELESS SIGNAL, AND OPERATING METHOD THEREFOR

(71) Applicant: LG INNOTEK CO., LTD., Seoul (KR)

(72) Inventor: Ki Min LEE, Seoul (KR)

(73) Assignee: LG INNOTEK CO., LTD., Seoul (KR)

(21) Appl. No.: 15/769,877

(22) PCT Filed: Oct. 14, 2016
(86) PCT No.: PCT/KR2016/011595

§ 371 Date: Apr. 20, 2018

(30) Foreign Application Priority Data
Oct. 23, 2015 (KR) 10-2015-0148356

(51) Int. Cl. H04B 5/00; H02J 50/12; H02J 50/80; H02J 7/02

(52) U.S. Cl. CPC H04B 5/0031; H04B 5/0037; H02J 50/12; H04W 4/80; H02J 7/027; H02J 7/025; H02J 50/80

(57) ABSTRACT

Embodiments provide a method for transmitting and receiving a wireless signal of a transmitter according to an embodiment including an operation for transmitting a signal for detecting a receiver, an operation for receiving an identification signal from the receiver, an operation for transmitting wireless power to the receiver, an operation for performing short-range communication with the receiver, and an operation for performing installation and/or execution of the application of the receiver by performing short-range communication with the receiver and transmitting location information of the transmitter to the receiver. Also, provided is a transmitter, a receiver, a system for transmitting/receiving a wireless signal, in which wireless power transmission may be suspended when performing short-range communication with the receiver, and a driving method thereof.

### TECHNICAL FIELD

The present disclosure relates to a wireless power transmitter, a wireless power receiver, and a wireless system for transmitting and receiving wireless signals, and an operation method thereof and more particularly, to a wireless system including a wireless short-range communication system and a wireless power transfer system.

### BACKGROUND ART

Generally, various electronic devices are equipped with a battery and are driven by using power charged in the battery. At this time, the battery in the electronic device may be replaced and charged again. For this, the electronic device has a contact terminal for contact with an external charging device. That is, the electronic device is electrically connected to the charging device through the contact terminal. However, as the contact terminal in an electronic device is exposed to the outside, it may be contaminated by foreign matter or short-circuited by moisture. In this case, there is a problem that a contact failure occurs between the contact terminal and the charging device, and the battery is not charged in the electronic device.

In order to solve the above problem, a wireless power transfer system for charging an electronic device wirelessly has been proposed.

The wireless power transfer system is a technology that delivers power without wires through space, thereby maximizing the convenience of supplying power to mobile devices and digital home appliances.

The wireless power transfer system has advantages such as saving energy by controlling real time power use, overcoming space limit of power supply, and reducing waste battery discharge by battery recharging.

As a method of implementing a wireless power transfer system, there are typically a magnetic induction method and a magnetic resonance method. The magnetic induction method, as a non-contact energy transmission technique in which two coils are close to each other, a current is supplied to one coil at one side, and a power is generated in a coil at the other side via a magnetic flux generated according thereto, may use frequency of several hundred kHz. The magnetic resonance method, as a magnetic resonance technique using only electric field or magnetic field without using electromagnetic wave or current, may use a band of several MHz, with a power transmission distance of several meters or more.

The wireless power transfer system includes a transmitter that transmits power wirelessly and a receiver that receives power to charge a load such as a battery. At this time, a transmitter for selecting the charging method of a receiver, that is, a charging method of either the magnetic induction method or the magnetic resonance method, and transmitting power wirelessly in response to the charging method of the receiver has been developed.

Such a wireless power transfer system may transmit power in a way that wirelessly transmits the power induced on the coil.

### DISCLOSURE OF THE INVENTION

### Technical Problem

The embodiment provides a service to a user using a wireless system including a short-range communication system and a wireless power transfer system.

### Technical Solution

Embodiments of the present invention provide a method for transmitting and receiving a wireless signal of a transmitter according to an embodiment including an operation for transmitting a signal for detecting a receiver, an operation for receiving an identification signal from the receiver, an operation for transmitting wireless power to the receiver, an operation for performing short-range communication with the receiver, and an operation for performing installation and/or execution of the application of the receiver by performing short-range communication with the receiver and transmitting location information of the transmitter to the receiver.

In other embodiments of the present invention, A method for transmitting and receiving a wireless signal of a receiver according to an embodiment of the present invention includes an operation for transmitting a response signal to the detection signal from the transmitter, an operation for transmitting an identification signal to the transmitter, an operation for receiving wireless power from the transmitter, an operation for performing short-range communication with the transmitter, an operation for performing installation and/or execution of an application by performing short-range communication with the transmitter and receiving location information of the transmitter, an operation for transmitting the first information to the server in response to the execution of the application, and an operation for receiving the second information from the server in response to the first information.

In still other embodiments of the present invention, A transmitter for transmitting/receiving a wireless signal includes: a transmission coil configured to transmit a detection signal of a receiver or wireless power; a short-range communication coil configured to communicate with a short-range communication coil of the receiver to allow an application of the receiver to be installed and/or executed and to transmit location information; and a control unit configured to receive an identification signal from the receiver.

In even other embodiments of the present invention, a receiver for transmitting/receiving a wireless signal includes: a reception coil for receiving a detection signal or wireless power from a transmitter; a short-range communication coil configured to communicate with a short-range communication coil of the transmitter to allow an application to be installed and/or executed and to receive location information of the transmitter; and a control unit configured to transmit first information to a server in response to execution of the application and receive second information from the server in response to the first information.

In yet other embodiments of the present invention, A method of driving a system for transmitting/receiving a wireless signal includes: transmitting location information of a transmitter to a receiver and installing and/or executing an application of the receiver in response to short-range communication; charging the receiver by wireless power from the transmitter; transmitting first information to a server in response to execution of the application; transmitting second information of the server to the receiver in response to the first information; and transmitting the first information to a service computer.

### Advantageous Effects

Embodiments may improve the convenience of user service by using a wireless system including a short-range communication system and a wireless power transfer system.

### BRIEF DESCRIPTION OF THE DRAWINGS

FIG. 1 is a magnetic induction type equivalent circuit.

FIG. 2 is a magnetic resonance type equivalent circuit.

FIGS. 3A and 3B are block diagrams illustrating a transmitter as one of the subsystems constituting the wireless power transfer system.

FIG. 3C is a specific circuit diagram of the transmission-side power conversion unit according to the embodiment.

FIG. 3D is a top view of the transmitter.

FIGS. 4A and 4B are block diagrams illustrating a receiver as one of the subsystems constituting the wireless power transfer system.

FIG. 5 is a flowchart illustrating an operation of a wireless power transfer system on the basis of an operation state of a transmitter according to an embodiment of the present invention.

FIG. 6 is a flowchart according to a wireless power transfer and a short-range communication between a transmitter and a receiver.

FIG. 7 is a flowchart illustrating an operation method of a receiver.

FIG. 8 is a flowchart illustrating a method for determining a desired power of a receiver.

FIG. 9 is a view showing a wireless signal transmission/reception system.

FIG. 10 is a flowchart illustrating a method of driving a wireless signal transmission/reception system.

FIGS. 11 and 12 are operational flowcharts showing the operation relationship between wireless charging and short-range communication.

FIG. 13 is a flowchart of the operation of a golf zone system as one embodiment.

### MODE FOR CARRYING OUT THE INVENTION

Hereinafter, a wireless signal transmission/reception system and a driving method thereof according to an embodiment of the present invention will be described in detail with reference to the drawings. The following embodiments are provided as examples so that those skilled in the art may fully understand the spirit of the present invention. Therefore, the present invention is not limited to the embodiments described below, but may be embodied in other forms. Furthermore, in the drawings, the size and thickness of a device may be exaggerated for convenience. Like reference numerals designate like elements throughout the specification.

For wireless power transmission, the embodiment may selectively use various kinds of frequency bands from low frequency (50 kHz) to high frequency (15 MHz) and may include a communication system capable of exchanging data and control signals for system control.

The embodiment may be applied to various industrial fields such as a mobile terminal industry, a smart watch industry, a computer and notebook industry, a household appliance industry, an electric car industry, a medical device industry, and a robot industry, which use electronic devices that use or require batteries.

The Embodiment may consider a system capable of power transmission to one or more multiple devices using one or more transmission coils.

According to the embodiment, it is possible to solve the battery shortage problem in a mobile device such as a smart phone or a notebook. For example, when a user places a wireless charging pad on a table and uses a smartphone or notebook on it, the battery may be automatically charged and may be used for a long time. Also, by installing a wireless charging pad in a public place such as a café, an airport, a taxi, an office, a restaurant, etc., a mobile device manufacturer may charge various mobile devices regardless of the charging terminal. Also, when wireless power transfer technology is applied to household appliances such as vacuum cleaners and electric fans, there is no need to look for power cables and the complicated wires disappear in the home, so that wiring in buildings may be reduced and space utilization may be widened. Also, it takes a lot of time to charge an electric car with current household power. However, transmitting high power through wireless power transfer technology may reduce charging time, and installing the wireless charging facility on the parking lot may eliminate the inconvenience of preparing the power cable around the electric car.

The terms and abbreviations used in the examples are as follows.

Wireless power transfer system: it may refer to a system that provides wireless power transmission within a magnetic field region.

Wireless power transfer system-charger; power transfer unit: it may be a device for providing wireless power transfer to a power receiver within a magnetic field area and managing the entire system and may be referred to as a transmission device or a transmitter. According to an embodiment, the power transfer unit may be referred to as a transmitter or a wireless power transmitter.

Wireless power receiver system-device; power receiver unit: it may be a device for receiving wireless power transfer from a power transmitter within a magnetic field area and may be referred to as a reception device or a receiver. According to an embodiment, the power receiver unit may be referred to as a receiver or a wireless power receiver.

Charging area: it may be an area where actual wireless power transmission occurs within the magnetic field area, and vary depending on the size of the application, the power demanded, and the operating frequency.

Scattering (S) parameter: it may be the ratio of the input voltage to the output voltage on the frequency distribution, and may mean the ratio (the transmission; S21) of the input port to the output port or the self reflection value of each input/output port, that is, the value (reflection; S11 and S22) of the output reflected by its input.

Quality index Q (quality factor): the value of Q in resonance means the quality of frequency selection. As the Q value is higher, the resonance characteristics are better. The Q value may be expressed as the ratio of the energy stored in the resonator to the energy lost.

As for the principle of transmitting power wirelessly, there are largely magnetic induction type and magnetic resonance type as the principle of wireless power transmission.

The magnetic induction method is a non-contact energy transfer technology in which power is generated in the load inductor Ll through the magnetic flux as a medium generated when the source inductor Ls and the load inductor Ll are close to each other and a current is supplied to the source inductor Ls at one side. And the magnetic resonance method is a technology for transferring energy wirelessly using the resonance technique in which by combining two resonators, the magnetic resonance due to the natural frequency between the two resonators occurs, so that they oscillate at the same frequency and form an electric field and a magnetic field in the same wavelength range.

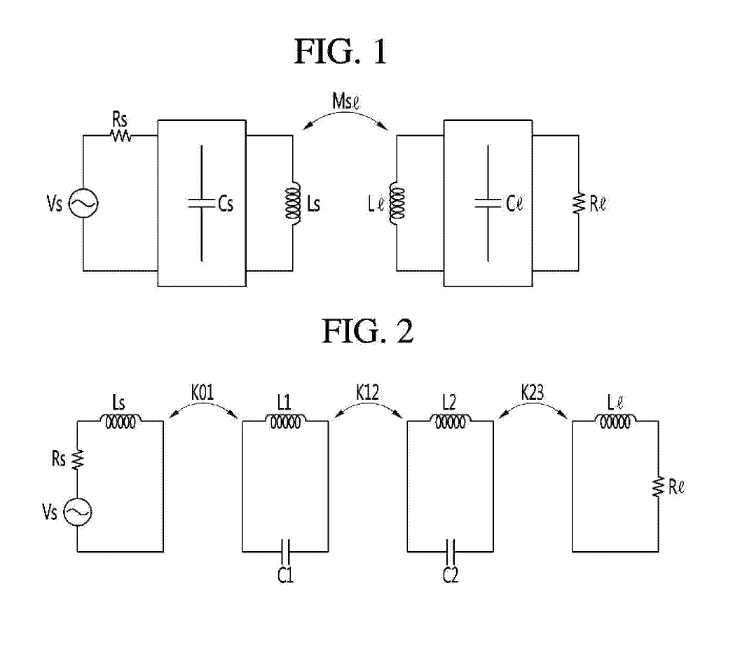

FIG. 1 is a magnetic induction type equivalent circuit.

Referring to FIG. 1, in a magnetic induction type equivalent circuit, a transmitter may be implemented with a source voltage Vs, a source resistance Rs, a source capacitor Cs for impedance matching, and a source coil Ls for magnetic coupling with a receiver according to a device for supplying power. The receiver may be implemented with a load resistor Rl, which is the equivalent resistance of the receiver, a load capacitor Cl for impedance matching, and a load coil Ll for magnetic coupling with the transmitter. The degree of magnetic coupling between the source coil Ls and the load coil Ll may be represented by mutual inductance Msl.

In FIG. 1, the ratio S21 of the input voltage to the output voltage is obtained from a magnetic induction equivalent circuit consisting only of a coil, without the source capacitor Cs and the load capacitor Cl for impedance matching. When the maximum power transmission condition is found therefrom, it satisfies Equation 1 below.

Equation 1

Ls/Rs=Ll/Rl

According to the above Equation 1, when the ratio of the inductance of the transmission coil Ls to the source resistance Rs and the ratio of the inductance of the load coil Ll to the load resistance Rl are the same, maximum power transmission is possible. In systems with only inductance, since there is no capacitor that compensates for reactance, at the point where maximum power transfer occurs, the value of the self reflection value S11 of the input/output port may not be zero, and the power transfer efficiency may vary greatly depending on the value of the mutual inductance Msl. Thus, a source capacitor Cs may be added to the transmitter as a compensation capacitor for impedance matching, and a load capacitor Cl may be added to the receiver. The compensation capacitor Cs or Cl may be connected in series or in parallel to the reception coil Ls and the load coil Ll, respectively. In addition, for impedance matching, each transmitter and receiver may be further equipped with passive components such as additional capacitors and inductors as well as compensation capacitors.

FIG. 2 is a magnetic resonance type equivalent circuit.

Referring to FIG. 2, in a magnetic resonance type equivalent circuit, the transmitter is implemented with a source coil constituting a closed circuit by a series connection of the source voltage Vs, the source resistance Rs and the source inductor Ls, and a transmission-side resonant coil constituting a closed circuit by a series connection of the transmission-side resonant inductor L1 and the transmission-side resonant capacitor C1. The receiver is implemented with a load coil constituting a closed circuit by a series connection of a load resistance Rl and a load inductor Ll, and a reception-side resonant coil constituting a closed circuit by a series connection of a reception-side resonant inductor L2 and a reception-side resonant capacitor C2. The source inductor Ls and the transmission inductor L1 are magnetically coupled with the coupling coefficient of K01. The load inductor Ll and the load-side resonant inductor L2 are magnetically coupled with the coupling coefficient of K23. The transmission-side resonant inductor L1 and the reception-side resonant inductor L2 are magnetically coupled with the coupling coefficient of K12. In the equivalent circuit of another embodiment, the source coil and/or the load coil may be omitted, and only the transmission-side resonant coil and the reception-side resonant coil may be used.

In the magnetic resonance method, when the resonance frequencies of two resonators are the same, most of the energy of the resonator of the transmitter is transferred to the resonator of the receiver to improve the power transfer efficiency. When the efficiency in the magnetic resonance method satisfies Equation 2, it becomes better.

Equation 2

k/Γ>>1 (k is a coupling coefficient, Γ is an attenuation rate)

In the magnetic resonance method, an element for impedance matching may be added to increase the efficiency, and the impedance matching element may be a passive element such as an inductor and a capacitor.

On the basis of the principle of wireless power transfer, a wireless power transfer system for transferring power through a magnetic induction method or a magnetic resonance method will be described.

<Transmitter>

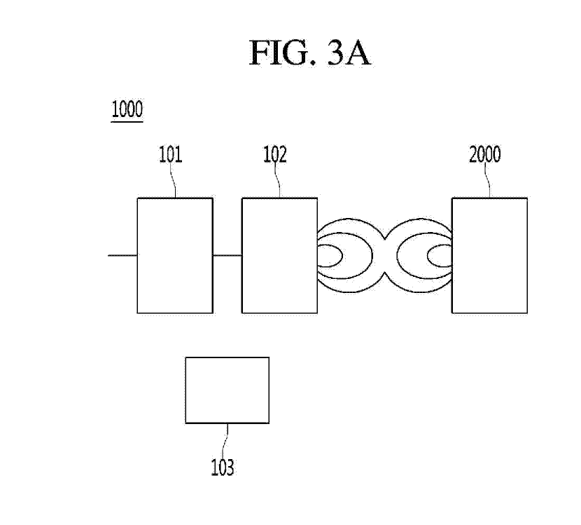

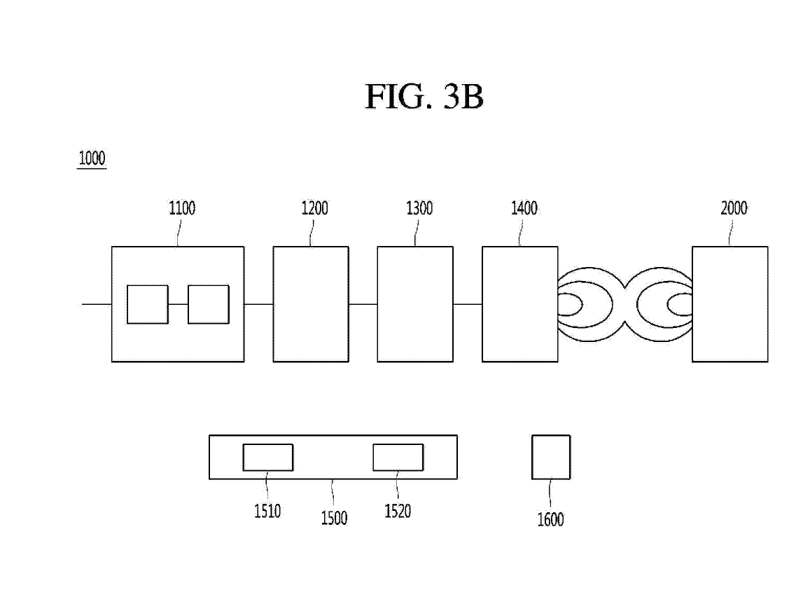

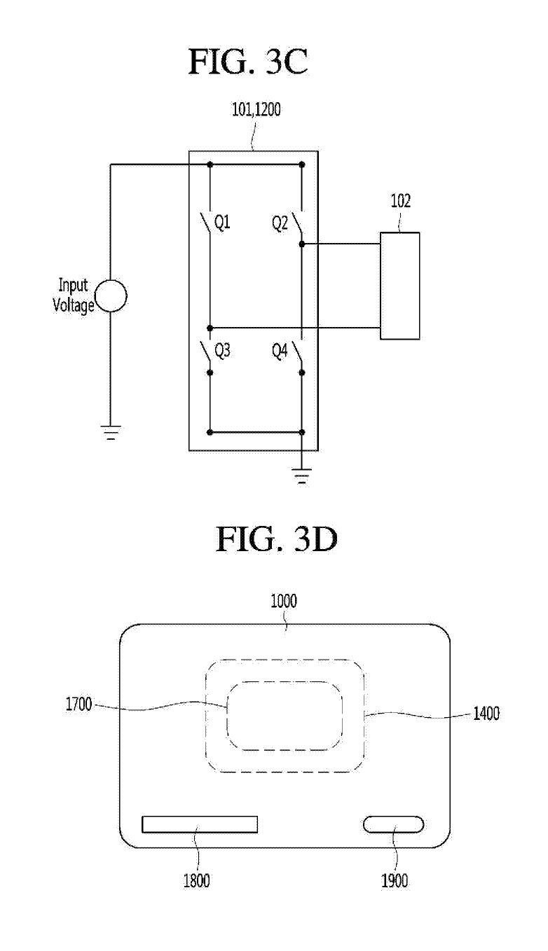

FIGS. 3A and 3B are block diagrams illustrating a transmitter as one of the subsystems constituting the wireless power transfer system. In addition, FIG. 3C is a specific circuit diagram of the transmission-side power conversion unit according to the embodiment. In addition, FIG. 3D is a top view of the transmitter.

Referring to FIG. 3A, a wireless power transfer system according to an embodiment of the present invention may include a transmitter 1000 and a receiver 2000 for wirelessly receiving power from the transmitter 1000. The transmitter 1000 may include a transmission-side power conversion unit 101 for power-converting the input AC signal and outputting it as an AC signal, a transmission-side resonance circuit unit 102 for generating a magnetic field on the basis of the AC signal outputted from the transmission-side power conversion unit 101 and providing power to the receiver 2000 in the charging area, and a transmission-side control unit 103 for controlling power conversion of the transmission-side power conversion unit 101, adjusting the amplitude and frequency of the output signal of the transmission-side power conversion unit 101, performing impedance matching of the transmission-side resonance circuit unit 102, sensing impedance, voltage, and current information from the transmission-side power conversion unit 101 and the transmission-side resonance circuit unit 102, and wirelessly communicating with the receiver 2000. The transmission-side power conversion unit 101 includes at least one of a power conversion unit for converting an AC signal into a DC, a power conversion unit for outputting a DC by varying the level of the DC, and a power conversion unit for converting a DC into an AC. Then, the transmission-side resonance circuit unit 102 may include a coil and an impedance matching unit capable of resonating with the coil. In addition, the transmission-side control unit 103 may include a sensing unit for sensing impedance, voltage, and current information and a wireless communication unit.

In addition, referring to FIG. 3B, the transmitter 1000 includes a transmission-side AC/DC conversion unit 1100, a transmission-side DC/AC conversion unit 1200, a transmission-side impedance matching unit 1300, a transmission coil unit 1400, and a transmission-side communication and control unit 1500.

The transmission-side AC/DC conversion unit 1100 is a power conversion unit for converting an AC signal provided from the outside into a DC signal under the control of the transmission-side communication and control unit 1500. The transmission-side AC/DC conversion unit 1100 may include a rectifier 1110 and a transmission-side DC/DC conversion unit 1120 as a subsystem. The rectifier 1110 is a system for converting a provided AC signal into a DC signal, and as an embodiment for realizing this, may be a diode rectifier having a relatively high efficiency in high frequency operation, a one-chip synchronous rectifier or a hybrid rectifier that saves cost and space and has a high degree of freedom in dead time. However, the present invention is not limited to this, and may be applied to a system that converts AC to DC. In addition, the transmission-side DC/DC conversion unit 1120 adjusts The level of the DC signal provided from the rectifier 1110 under the control of transmission-side communication and control unit 1500, and as an example for implementing this, may be a buck converter for lowering the level of the input signal, a boost converter for increasing the level of the input signal, a buck boost converter capable of raising or lowering the level of the input signal, or a cuk converter. In addition, the transmission-side DC/DC conversion unit 1120 may include a switch element with power conversion control function, an inductor and capacitor for a power conversion medium role or an output voltage smoothing function, and a transformer for a voltage gain control or electrical isolation function. It is possible to remove the ripple component or the pulsation component (AC component included in the DC signal) included in the inputted DC signal. The, an error between the command value of the output signal of the transmission-side DC/DC conversion unit 1120 and the actual output value may be adjusted through a feedback method, and this is performed by the transmission-side communication and control unit 1500.

The transmission-side DC/AC conversion unit 1200 is a system for converting a DC signal outputted from the transmission-side AC/DC conversion unit 1100 into an AC signal and controlling the frequency of the converted AC signal under the control of transmission-side communication and control unit 1500, and as an example for implementing this, may be a half bridge inverter or a full bridge inverter. Then, the wireless power transfer system may be applied to a variety of amplifiers that convert DC to AC. For example, class A, B, AB, C, and F amplifiers are available. Moreover, the transmission-side DC/AC conversion unit 1200 may include an oscillator for generating a frequency of an output signal and a power amplifier for amplifying an output signal.

In addition, the transmission-side power conversion unit 101 of FIG. 3A or the transmission-side DC/AC conversion unit 1200 of FIG. 3B may be driven as a half bridge inverter or a full bridge inverter as in FIG. 3C according to the control of the first to fourth switching elements Q1 to Q4.

For example, in a state in which the first switching element Q1 maintains the turn-off state and the fourth switching element Q4 maintains the turn-on state, as the second and third switching elements Q2 and Q3 are controlled to be turned on and off, it may be driven as a half bridge inverter, and as the first to fourth switching elements Q12 and Q4 are controlled to be turned on and off, it may be driven as the full bridge inverter.

The transmission-side DC/AC conversion unit 1200 according to the embodiment includes drives the second and third switching elements Q2 and Q3 alternately when the half bridge inverter is driven and drives the first and fourth switching elements Q1 and Q4 and the second and third switching elements Q2 and Q3 alternately when the full bridge inverter is driven.

In addition, the first to fourth switching elements Q1 to Q4 may be transistors.

In such a way, the transmission-side power conversion unit 101 of FIG. 3A or the transmission-side DC/AC conversion unit 1200 of FIG. 3B may be driven as the half bridge inverter to charge the low power class receiver 2000, and may be driven as the full bridge inverter to charge the middle power class receiver 2000.

The configuration of the AC/DC conversion unit 1100 and the transmission-side DC/AC conversion unit 1200 may be replaced with an AC power supply, or may be omitted or replaced with another configuration.

The transmission-side impedance matching unit 1300 minimizes the reflected wave at the points having different impedances to improve the signal flow. Since the two coils of transmitter 1000 and receiver 2000 are spatially separated, there is a large leakage of magnetic field, so that the power transmission efficiency may be improved by correcting the impedance difference between the two connection ends of the transmitter 1000 and the receiver 2000. The transmission-side impedance matching unit 1300 may include at least one of an inductor, a capacitor, and a resistor. By varying the inductance of the inductor, the capacitance of the capacitor, and the resistance value of the resistance under control of the communication and control unit 1500, the impedance value for impedance matching may be adjusted. And when the wireless power transfer system transmits power by the magnetic induction method, the transmission-side impedance matching unit 1300 may have a series resonant structure or a parallel resonant structure, and the inductance coupling coefficient between the transmitter 1000 and the receiver 2000 may be increased to minimize the energy loss. And when the wireless power transfer system transmits power by the magnetic resonance method, the transmission-side impedance matching unit 1300 may allow real-time correction of the impedance matching when the separation distance between the transmitter 1000 and the receiver 2000 is changed or according to the matching impedance change on the energy transmission line due to changes in the characteristics of coils according to the mutual influences by metallic foreign objects and many devices. The correction method may be a multi-matching method using a capacitor, a matching method using a multi-antenna, or a method using a multi-loop.

The transmission-side coil 1400 may be implemented as a plurality of coils or a plurality of coils. When a plurality of transmission-side coils 1400 are provided, they may be arranged apart from each other or may be disposed in overlapping relation to each other. When they are superimposed and arranged, the overlapping area may be determined in consideration of the deviation of the magnetic flux density. Also, when fabricating the transmission-side coil 1400, it may be manufactured in consideration of the internal resistance and the radiation resistance. When the resistance component is small, the quality factor may be increased and the transmission efficiency may be increased.

The communication and control unit 1500 may include a transmission-side control unit 1510 and a transmission-side communication unit 1520. The transmission-side control unit 1510 may control an output voltage of the transmission-side AC/DC conversion unit 1100 (or a current Itx_coil flowing in the transmission coil) in consideration of at least one of the power demand of the receiver 2000, current charge, the voltage Vrect at the rectifier output terminal of the receiver, each charging efficiency of multiple receivers, and the wireless power method. And in consideration of the maximum power transmission efficiency, the power to be transmitted may be controlled by generating frequency and switching waveforms for driving the transmission-side DC/AC conversion unit 1200. Also, the overall operation of the receiver 2000 may be controlled using an algorithm, a program or an application required for the control read from the storage unit (not shown) of the receiver 2000. Meanwhile, the transmission-side control unit 1510 may be referred to as a microprocessor, a micro controller unit, or a micom. The transmission-side communication unit 1520 may communicate with the reception-side communication unit 2620, and may use a short-range communication method such as Bluetooth, Near Field Communication (NFC), and Zigbee. The transmission-side communication unit 1520 and the reception-side communication unit 2620 may transmit and receive the charge status information and the charging control command to each other. The charge status information may include the number of the receivers 2000, the remaining battery charge, the number of charge cycles, the amount of usage, the battery capacity, the battery ratio, and the transmission power amount of the transmitter 1000. Also, the transmission-side communication unit 1520 may transmit a charging function control signal for controlling the charging function of the receiver 2000, and the charging function control signal may be a control signal that controls the receiver 2000 to enable or disable the charging function.

Likewise, the transmission-side communication unit 1520 may be communicated in an out-of-band format with separate modules, and is not limited thereto. It may use the feedback signal that the receiver transmits the feedback signal to the transmitter by using the power signal transmitted by the transmitter and may perform communication in an in-band format that the transmitter transmits a signal to the receiver by using the frequency of the power signal transmitted by the transmitter as a frequency shift. For example, the receiver may modulate the feedback signal to transmit information such as start of charge, end of charge, battery condition, etc. to the transmitter through a feedback signal. In addition, the transmission-side communication unit 1520 may be configured separately from the transmission-side control unit 1510, and the receiver 2000 may also include a reception-side communication unit 2620 connected to a control unit 2610 or may be separately configured.

In addition, the transmitter 1000 of the wireless power transfer system according to the embodiment may further include a detection unit 1600.

The detection unit 1600 may detect at least one of the input signal of the transmission-side AC/DC conversion unit 1100, the output signal of transmission-side AC/DC conversion unit 1100, the input signal of the transmission-side DC/AC conversion unit 1200, the output signal of the transmission-side DC/AC conversion unit 1200, the input signal of transmission-side impedance matching unit 1300, the output signal of transmission-side impedance matching unit 1300, the input signal of transmission-side coil 1400, or the signal on the transmission-side coil 1400. For example, the signal may include at least one of information on a current, information on a voltage, and information on an impedance. The detected signal is fed back to the communication and control unit 1500. On the basis of this, the communication and control unit 1500 may control the transmission-side AC/DC conversion unit 1100, the transmission-side DC/AC conversion unit 1200, and the transmission-side impedance matching unit 1300. Further, on the basis of the detection result of the detection unit 1600, the communication and control unit 1500 may perform foreign object detection (FOD). And the detected signal may be at least one of a voltage and a current. Meanwhile, the detection unit 1600 may be configured as hardware different from the communication and control unit 1500, or may be implemented as one hardware.

Referring to FIG. 3D, the transmitter 1000 may include a transmission-side coil unit 1400 and a short-range communication coil unit 1700, and may include a display means for displaying wireless power transmission to the receiver 2000, a charging state, a short-range communication progress, or a display means 1800, such as a voice guidance system or an alarm system, and may include a hot key 1900 for performing predetermined operations in response to an external command.

<Receiver>

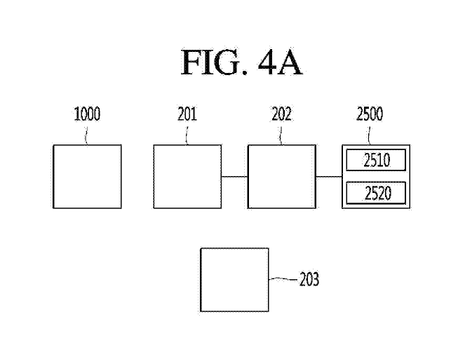

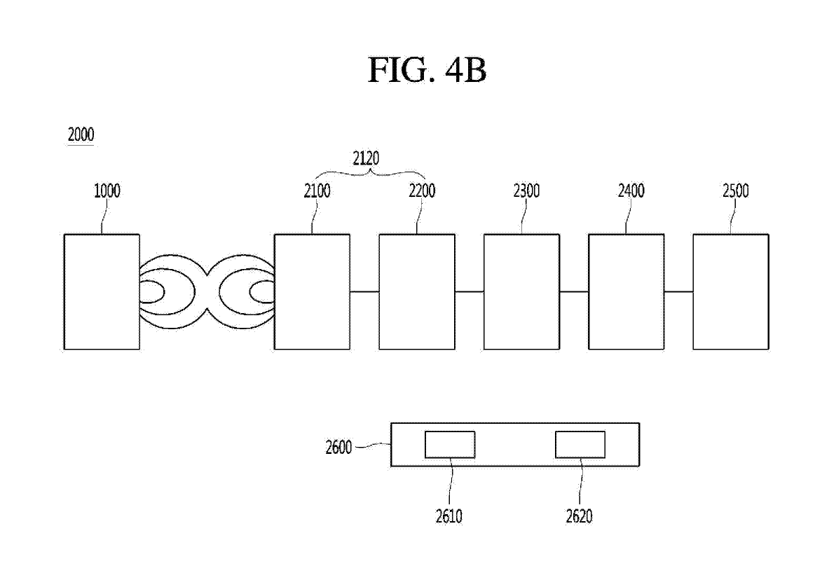

FIGS. 4A and 4B are block diagrams illustrating a receiver (or receiving device) as one of the subsystems constituting the wireless power transfer system. Referring to FIG. 4A, a wireless power transfer system according to an embodiment of the present invention may include a transmitter 1000 and a receiver 2000 for wirelessly receiving power from the transmitter 1000. The receiver 2000 may include a reception-side resonance circuit unit 201 for receiving an AC signal transmitted from the transmitter 1000, a reception-side power conversion unit 202 for power-converting the AC power from the reception-side resonance circuit unit 201 and outputting it as a DC signal, a load 2500 charged by receiving the DC signal outputted from the reception-side power conversion unit 202, and reception-side control unit 203 for sensing the current voltage of the reception-side resonance circuit unit 201, performing the impedance matching of the reception-side resonance circuit unit 201, controlling the power conversion of the reception-side power conversion unit 202, adjusting the level of the output signal of the reception-side power conversion unit 202, sensing the input or output voltage or current of the reception-side power conversion unit 202, controlling whether the output signal of the reception-side power conversion unit 202 is supplied to the load 2500, and communicating with the transmitter 1000. Then, the reception-side power conversion unit 202 may include a power conversion unit for converting an AC signal into a DC signal, a power conversion unit for outputting a DC signal by varying the level of the DC signal, and a power conversion unit for converting a DC into an AC. In addition, referring to FIG. 4B, a wireless power transfer system according to an embodiment of the present invention includes a transmitter (or a transmission device) 1000 and a receiver 2000 for receiving wirelessly power from the transmitter 1000. The receiver 2000 may include a reception-side resonance circuit unit 2120 including a reception-side coil unit 2100 and a reception-side impedance matching unit 2200, a reception-side AC/DC conversion unit 2300, a DC/DC conversion unit 2400, a load 2500, and a reception-side communication and control unit 2600. Then, the reception-side AC/DC conversion unit 2300 may be referred to as a rectifying unit for rectifying the AC signal into a DC signal.

The reception-side coil unit 2100 may receive power through a magnetic induction method or a magnetic resonance method. As described above, according to the power receiving method, at least one of the induction coil and the resonant coil may be included.

In one embodiment, the reception-side coil unit 2100 may be disposed in a portable terminal together with an antenna for short-range communication (hereinafter, referred to as a short-range communication coil unit 2700). Then, the reception-side coil unit 2100 may be the same as the transmission-side coil unit 1400, and the dimensions of the reception antenna may vary depending on the electrical characteristics of the receiver 200.

The reception-side impedance matching unit 2200 performs impedance matching between the transmitter 1000 and the receiver 2000.

The reception-side AC/DC conversion unit 2300 rectifies an AC signal outputted from the reception-side coil unit 2100 to generate a DC signal. The output voltage of the reception-side AC/DC conversion unit 2300 may be referred to as a rectified voltage Vrect. The reception-side communication and control unit 2600 may detect or change the output voltage of the reception-side AC/DC conversion unit 2300, and may transmit to the transmitter 1000 status parameter information such as information on a minimum rectified voltage Vrect_min (referred to as a minimum output voltage Vrect_min), which is the minimum value of the output voltage of the reception-side AC/DC conversion unit 2300, a maximum rectified voltage Vrect_max (or the maximum output voltage Vrect_max), which is the maximum value, an optimal rectified voltage Vrect_set (referred to as an optimum output voltage Vrect_set) having any one of the values between the minimum value and the maximum value.

The reception-side DC/DC conversion unit 2400 may adjust the level of the DC signal outputted from the reception-side AC/DC conversion unit 2300 to the capacity of the load 2500.

The load 2500 may include a battery, a display, a sound output circuit, a main processor, a battery management unit, and various sensors. Then, the load 2500 may include at least a battery 2510 and a battery management unit 2520 as shown in FIG. 4A. The battery management unit 2520 may sense the state of charge of the battery 2510 to adjust the voltage and current applied to the battery 2510.

The reception-side communication and control unit 2600 may be activated by the transmission-side communication and the wake-up power from the control unit 1500 and communicate with the transmission-side communication and control unit 1500 and control the operation of the subsystem of the receiver 2000.

The receiver 2000 may include a single or a plurality of receivers and may receive energy from the transmitter 1000 wirelessly at the same time. That is, in the wireless power transfer system of the magnetic resonance method, a plurality of target receivers 2000 may receive power from one transmitter 1000. In this case, the transmission-side matching unit 1300 of the transmitter 1000 may adaptively perform impedance matching between the plurality of receivers 2000. This may be applied equally to a plurality of independent reception-side coil units in the magnetic induction method.

In addition, when the receiver 2000 includes a plurality of receivers, the power receiving method may be the same system or different types of systems. In this case, the transmitter 1000 may be a system for transmitting power by a magnetic induction method or a magnetic resonance method, or a system in which both methods are mixed.

Meanwhile, as to the size and frequency of the signal of the wireless power transfer system, for the wireless power transmission of the magnetic induction method, in the transmitter 1000, the transmission-side AC/DC conversion unit 1100 may receive an AC signal of tens or hundreds of Hz (for example, 60 Hz) of several tens or hundreds of volts (for example, 110 to 220 volts) and convert it into a DC signal of several V to several tens V and several hundred V (for example, 10V to 20V). The transmission-side DC/AC conversion unit 1200 may receive a DC signal and output an AC signal of KHz band (e.g., 125 KHz). And, the reception-side AC/DC conversion unit 2300 of the receiver 2000 receives an AC signal of KHz band (for example, 125 KHz) to convert it into a DC signal of several V to several tens V, several hundred V (for example, 10V to 20V), and output it. The reception-side DC/DC conversion unit 2400 may output a DC signal of, for example, 5V suitable for the load 2500 and transmit it to the load 2500. And, in the case of wireless power transmission of the magnetic resonance method, in the transmitter 1000, the transmission-side AC/DC conversion unit 1100 may receive an AC signal of tens or hundreds of Hz (e.g., 60 Hz) of tens or hundreds of volts (e.g., 110V to 220V) and convert and output a DC signal of several V to several tens V, several hundred V (for example, 10V to 20V). The transmission-side DC/AC conversion unit 1200 may receive a DC signal and output an AC signal of MHz band (e.g., 6.78 MHz). And, the reception-side AC/DC conversion unit 2300 of the receiver 2000 may receive an AC signal of MHz (e.g., 6.78 MHz) and convert it into a reception-side DC signal of several V to several tens V, several hundred V (for example, 10 V to 20 V). The DC/DC conversion unit 2400 may output a DC signal of, for example, 5V suitable for the load 2500 and transmit it to the load 2500.

<Transmitter Operating Phase: Transmitter's Wireless Signal Transmission Method>

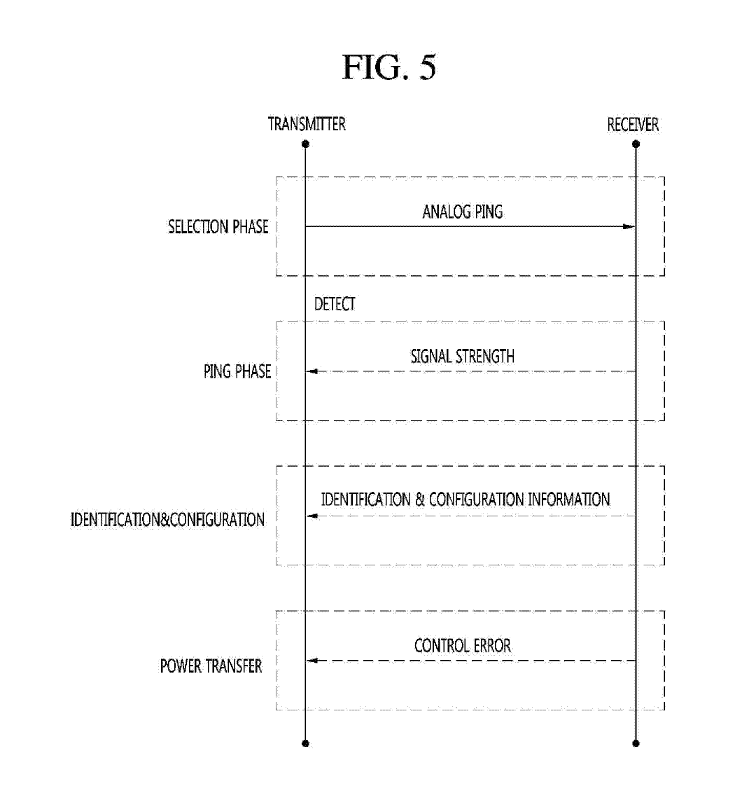

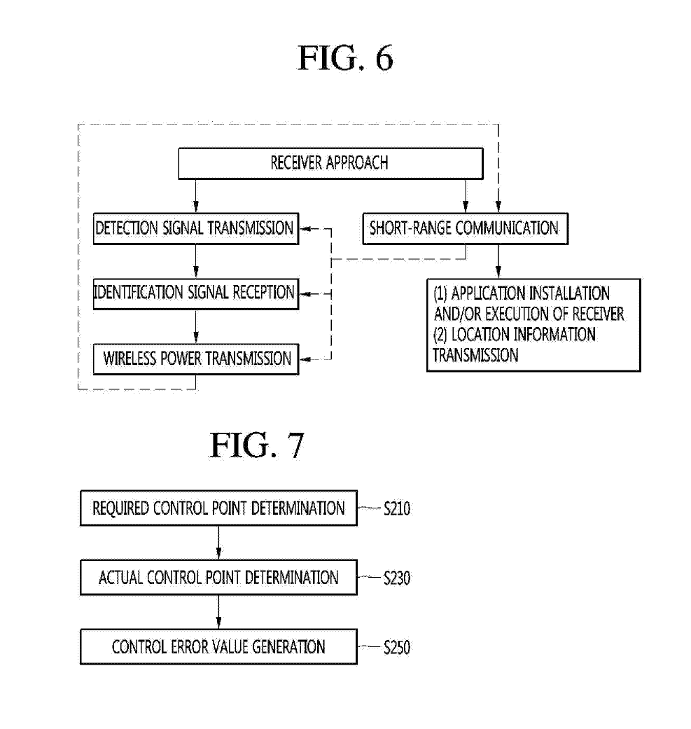

FIG. 5 is a flowchart illustrating an operation of a wireless power transfer system on the basis of an operating phase of a transmitter according to an embodiment of the present invention. Also, FIG. 6 is a flowchart according to a wireless power transfer and a short-range communication between a transmitter and a receiver.

Referring to FIG. 5, a transmitter according to an embodiment may have at least 1) a selection phase, 2) a ping phase, 3) an identification and setting phase, 4) a power delivery phase, and 5) a charge end phase.

[Selection Phase]

(1) In the selection phase, the transmitter 1000 may perform a detection process to select a receiver 200 in the sensing area or the charging area.

(2) The sensing area or the charging area may refer to an area where an object in the area may affect the characteristics of the power of the transmission-side power conversion unit 101, as described above. Compared with the detection phase, the detection process for selecting the receiver 2000 in the selection phase detects that the amount of power for forming a wireless power signal changes in the power conversion unit at the side of the transmitter 1000 to check whether an object exists within a certain range instead of a method of receiving a response from the receiver 2000 using a power control message. The detection process in the selection phase may be referred to as an analog detection process (analog ping) in that an object is detected using a wireless power signal instead of using a digital format packet in a detection phase described later.

(3) In the selection phase, the transmitter 1000 may detect that an object enters or exits the sensing area or the charging area. In addition, the transmitter 1000 may distinguish between a receiver 2000 capable of transmitting wirelessly power and other objects (e.g., keys, coins, etc.) among objects in the sensing area or the charging area.

As described above, since the distances at which power is wirelessly transmitted are different according to the inductive coupling method and the resonant coupling method, the sensing areas where objects are detected in the selection phase may be different from each other.

(4) First, when power is transmitted according to the inductively coupled method, the transmitter 1000 of the selection phase may monitor the interface surface (not shown) to detect the placement and removal of objects.

In addition, the transmitter 1000 may also sense the location of the wireless power receiver 2000 on top of the interface surface.

(5) When the transmitter 1000 includes one or more transmission coils, it may enter the ping phase from the selection phase, check whether or not a response to the detection signal is transmitted from the object using each coil in the ping phase, or thereafter enter the identification phase and confirm whether identification information is transmitted from the object.

The transmitter 1000 may determine a coil to be used for wireless power transmission on the basis of the position of the sensed receiver 2000 obtained through the above process.

(6) Also, when power is transmitted according to the resonance coupling method, the transmitter 1000 of the selection phase may detect the object by detecting that at least one of frequency, current, and voltage of the power conversion unit due to an object in the sensing area or the charging area is changed.

(7) Meanwhile, the transmitter 1000 of the selection phase may detect an object by at least one of detection methods according to the inductive coupling method and the resonant coupling method.

(8) The transmitter 1000 may perform an object detection process according to each power transmission method, and may then select a method of detecting the object from a coupling method for wireless power transmission in order to proceed to other phases.

(9) Meanwhile, in relation to the transmitter 1000 of the selection phase, a wireless power signal formed for detecting and object and a wireless power signals formed for digital detection, identification, setup, and power transmission in subsequent phases may have different characteristics such as frequency and intensity. This is because the selection phase of the transmitter 1000 corresponds to an idle phase for detecting an object, so that the transmitter 1000 may reduce the power consumption in the air or generate a specialized signal for efficient object detection.

[Ping Phase]

(1) In the ping phase, the transmitter 1000 may perform a process of detecting a receiver 2000 existing in a sensing area or a charging area through a power control message. The detection process in the ping phase may be referred to as a digital ping in comparison with the detection process of the receiver 2000 using the characteristics of the wireless power signal in the selection phase.

(2) The transmitter 1000 may form a wireless power signal for detecting the receiver 2000, demodulates the wireless power signal modulated by the receiver 2000, and obtain a power control message in the form of digital data corresponding to a response to the detection signal from the demodulated wireless power signal.

(3) The transmitter 1000 may recognize the receiver 2000 as a power transmission target by receiving a power control message corresponding to a response to the detection signal.

(4) The detection signal formed by the transmitter 1000 in the ping phase to perform the digital detection process may be a wireless power signal formed by applying a power signal of a specific operating point for a predetermined time.

The operating point here may refer to the frequency, duty cycle, and amplitude of the voltage applied to the transmission coil unit 1400.

The transmitter 1000 may generate the detection signal generated by applying the power signal of the specific operating point for a certain period of time and attempt to receive a power control message from the receiver 2000.

(5) Meanwhile, the power control message corresponding to the response to the detection signal may be a message indicating the strength of the wireless power signal received by the receiver 2000. For example, the receiver 2000 may transmit a signal strength packet including a message indicating the strength of the wireless power signal received as a response to the detection signal. The packet may be configured to include a header indicating that it is a packet indicating the signal strength and a message indicating the strength of the power signal received by the receiver 2000. The strength of the power signal in the message may be a value indicating the degree of coupling of inductive coupling or resonant coupling for power transmission between the transmitter 1000 and the receiver 2000.

(6) The transmitter 1000 may receive the response message to the detection signal, detect the receiver 2000, and then extend the digital detection process to enter the identification and ping phase. That is, the transmitter 1000 may receive the power control message necessary for the identification and ping phase by maintaining the power signal of the specific operating point after discovering the receiver 2000.

However, when the transmitter 1000 does not find a receiver 2000 capable of transmitting power, the operating phase of the transmitter 1000 may return to the selection phase.

[Identification and Configuration Phase]

(1) In the identification and configuration phase, the transmitter 1000 receives identification information and/or configuration information transmitted from the receiver 2000, and controls power transmission to be efficiently performed.

(2) In the identification and configuration phase, the receiver 2000 may transmit a power control message including its identification information. For this, the receiver 2000 may transmit an identification packet including a message indicating identification information of the receiver 2000, for example. The packet may be configured to include a header indicating that it is a indicating the identification information and a message including the identification information of the receiver 2000. The message may be configured to include information indicating a version of a protocol for wireless power transmission, information identifying a manufacturer of the receiver 2000, information indicating the presence or absence of an extension device identifier, and a base device identifier. In addition, when the extension device identifier is present in the information indicating the presence or absence of the extension device identifier, an extended identification packet including the extension device identifier may be separately transmitted. The packet may be configured to include a header indicating that it is packet indicating an extension device identifier and a message including an extension device identifier. In such a way, when an extension device identifier is used, to identify the receiver 2000, information on the basis of the identification information of the manufacturer, the base device identifier, and the extension device identifier may be used.

(3) In the identification and configuration phase, the receiver 2000 may transmit a power control message including information on the expected maximum power. For this, the receiver 2000 may transmit, for example, a configuration packet. The packet may be configured to include a header indicating a configuration packet and a message including information on the expected maximum power.

The message may be configured to include a power class, information on expected maximum power, an indicator indicating how to determine the current of the main cell at the side of the wireless power transmitter 1000, and the number of optional configuration packets. The indicator may indicate whether or not the current of the main cell at the side of the transmitter 1000 is to be determined as specified in the protocol for wireless power transmission.

(4) Meanwhile, the transmitter 1000 may generate a power transfer contract to be used for power charging with the receiver 2000 on the basis of the identification information and/or the setting information. The power transfer contract may include limits of parameters that determine power transfer characteristics in the power delivery phase.

(5) The transmitter 1000 may terminate the identification and configuration phase and return to the selection phase before entering the power delivery phase. For example, the transmitter 1000 may terminate the identification and configuration phase to find another receiver 2000 capable of receiving wirelessly power.

[Power Transfer Phase]

(1) The transmitter 1000 in the power transfer phase transmits power to the receiver 2000.

(2) In this case, the transmitter 1000 may wirelessly transmit power by controlling the power conversion unit 101 according to the version of the receiver 2000 on the basis of the received identification packet. Specifically, when the receiver 2000 corresponds to a low power level by checking the version of the receiver 2000, the power conversion unit 101 may be driven by a half bridge inverter to transmit wireless power. When the receiver 2000 corresponds to a middle power class, the power conversion unit 101 may be driven by a full bridge inverter to transmit wireless power.

(3) The transmitter 1000 may receive a power control message from the receiver 2000 during power transmission, and adjust a characteristic of a power applied to the transmission coil unit 1400 according to the received power control message. For example, a power control message used to adjust the power characteristic of the transmission coil may be included in a control error packet. The packet may be configured to include a header indicating a control error packet and a message including a control error value. The transmitter 1000 may adjust the power applied to the transmission coil according to the control error value. That is, when the control error value is 0, since the desired control point of the receiver 2000 is substantially the same as the actual control point of the receiver 2000, the current applied to the transfer coil is maintained. The current may be reduced when it is a negative value, and may be increased when it is a positive value.

(4) Also, in relation to the transmitter 1000, at the start of the power transfer phase, the power conversion unit 101 is driven as the half bridge inverter. After receiving the first control error packet, the power conversion unit 101 determines the version of the receiver 2000 on the basis of the already received identification packet. When the receiver 2000 corresponds to a low power class, the power conversion unit 101 may maintain the bridge inverter operation of the power conversion unit 101 and in the middle power class, may change to the full bridge inverter drive.

(5) In the power transfer phase, the transmitter 1000 may monitor parameters in a power transfer contract generated on the basis of the identification information and/or the setting information. As a result of monitoring the parameters, when the power transmission to the receiver 2000 violates the limits contained in the power transfer contract, the transmitter 1000 may cancel the power transmission and return to the selection phase.

(6) The power transfer contract may also include boundary conditions regarding the characteristics of the power transmitted from the transmitter 1000 to the receiver 2000.

(7) The transmitter 1000 may terminate the power transfer phase on the basis of the power control message transmitted from the receiver 2000.

For example, when the receiver 2000 completes the charging of the battery while charging the battery using the transmitted power, it may transmit a power control message requesting the transmitter 1000 to suspend wireless power transmission. In this case, the transmitter 1000 may terminate the wireless power transmission and return to the selection phase after receiving the message requesting the suspension of the power transmission.

In another example, the receiver 2000 may deliver a power control message requesting renegotiation or reconfiguration to update an already generated power transfer contract. When more or less power than the amount of power currently being transmitted is required, the receiver 2000 may deliver a message requesting renegotiation of the power transfer contract. In this case, after the transmitter 1000 receives a message requesting renegotiation of the power transfer contract, it may terminate the wireless power transmission and return to the identification and configuration phase.

For this, the message transmitted by the receiver 2000 may be, for example, an end power transfer packet as shown in FIG. 18. The packet may be configured to include a header indicating that the packet is an end power transfer packet and a message including a power transmission interruption code indicating the reason for the interruption. The power transfer interruption code may indicate any one of charge complete, internal fault, over temperature, over voltage, over current, battery failure, reconfigure, no response, and unknown error.

(8) Furthermore, referring to FIG. 6, when the receiver 2000 approaches the transmitter 1000, through a short-range communication between the transmitter 1000 and the receiver 2000 in addition to the above-described transmission of wireless power between the transmitter and the receiver, an application installed in the receiver 2000 may be installed and/or executed, and the location information of the transmitter 1000 may be transmitted to the receiver 2000.

(9) When short-range communication is performed in the power transfer phase, wireless power transmission may be suspended temporarily before short-range communication is performed, and wireless power transmission may be resumed after the short-range communication is completed.

(10) When short-range communication is performed in a specific state for wireless power transmission, the specific state for the wireless power transmission may be suspended temporarily, and the state may be resumed after the short-range communication is completed. Therefore, after short-range communication, it may proceed to any one of detection signal transmission, identification packet reception, or wireless power transmission.

<Operation Method of Receiver: Signal Transmission/Reception Method of Receiver>

FIG. 7 is a flowchart illustrating an operation method of a receiver.

Referring to FIG. 7, when the receiver 2000 approaches the transmitter 1000, at least one of operations for wireless power transfer and communication with the transmitter 1000 according to short-range communication may be performed.

(1) As described above in FIG. 5, the receiver 2000 may transmit a response signal in response to a detection signal from the transmitter 1000 and transmit an identification packet to the transmitter 1000, and the receiver 2000 may receive wireless power from the transmitter 1000.

(2) Furthermore, the receiver 2000 may perform short-range communication with the transmitter 1000, install and/or execute a predetermined application according to the short-range communication, and receive the location information of the transmitter 1000.

(3) Moreover, when short-range communication is performed during wireless power reception, wireless power reception may be suspended temporarily and wireless power reception may be resumed after short-range communication is terminated.

(4) Furthermore, when short-range communication is performed in a specific operation for receiving wireless power, the specific operation for receiving wireless power may be suspended temporarily and the operation suspended after short-range communication may be resumed. Therefore, after short-range communication, it is possible to proceed to any one of operation of transmission of response signal, transmission of identification packet, or reception of wireless power.

(5) Also, the predetermined first information may be transmitted to the server according to the automatic execution of the application of the receiver 2000, and the second information may be received from the server in response to the first information, and the service computer may be controlled according to a command from the user received through the application.

<Desired Power Determination Method of Receiver>

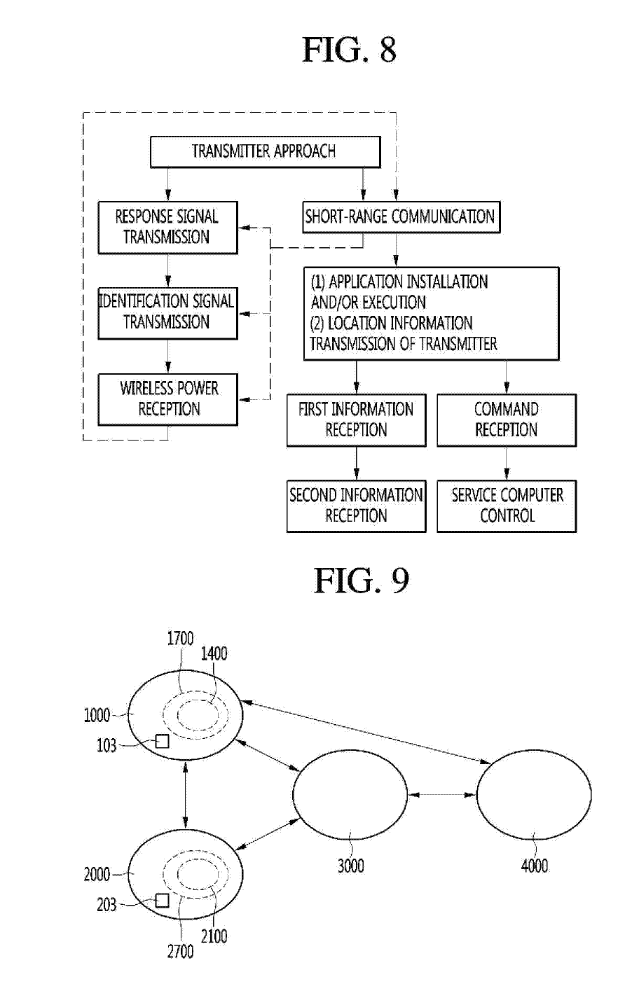

FIG. 8 is a flowchart illustrating a method for determining a desired power of a receiver.

Referring to FIG. 8, the receiver 2000 may determine the power to receive, that is, the desired power, by performing 1) operation S210 for determining a desired control point, 2) operation S230 for detecting an actual control point, 3) operation S250 for generating a control error value.

Specifically, in operation S210 for determining a desired control point, the receiver 2000 may determine the required control point for voltage, current, temperature, and so on. Then, in operation S230 for detecting an actual control point, the receiver 2000 may determine the actual control point for actual voltage, current, temperature, and so on. When the receiver 2000 determines the actual control point, various methods such as voltage and current detection and temperature sensing may be applied, and such a process may be performed at any time during the power transfer phase. And, in operation S250 for generating a control error value, the receiver 2000 may generate a control error value on the basis of the difference between the required control voltage value and the actual control voltage value, for example. And, the control error value may be a parameter indicating a positive value and a negative value. When the actual power amount is smaller than the required power amount, the control error value may refer to a positive value. When the actual power amount is larger than the required power amount, the control error value may refer to a negative value. When the required power amount and the actual power amount are the same, they may have a value of zero. In this way, in the power control process, the coupling coefficient may be drastically lowered according to the alignment between the transmitter 1000 and the receiver 2000, so that the desired power amount of the receiver 2000 may be instantaneously increased. In addition, the receiver 2000 may request the transmitter 1000 to have a desired power amount such that the current induced in the reception-side coil unit 2100 exceeds the threshold value. However, on the basis of the threshold of the current induced in the reception-side coil unit 2100, in relation to the transmitter 1000, since the wireless power generated within the reconfigured driving frequency range is transmitted, the problem of damaging the receiver 2000 is prevented.

Meanwhile, the control error value may be transmitted to the transmitter 1000 in the form of a control error packet.

When a new transmission power is received from the transmitter that received the control error value, it may be determined through the operation described above whether the new transmission power satisfies the required power.

<Wireless Signal Transmission/Reception System and Driving Method Thereof>

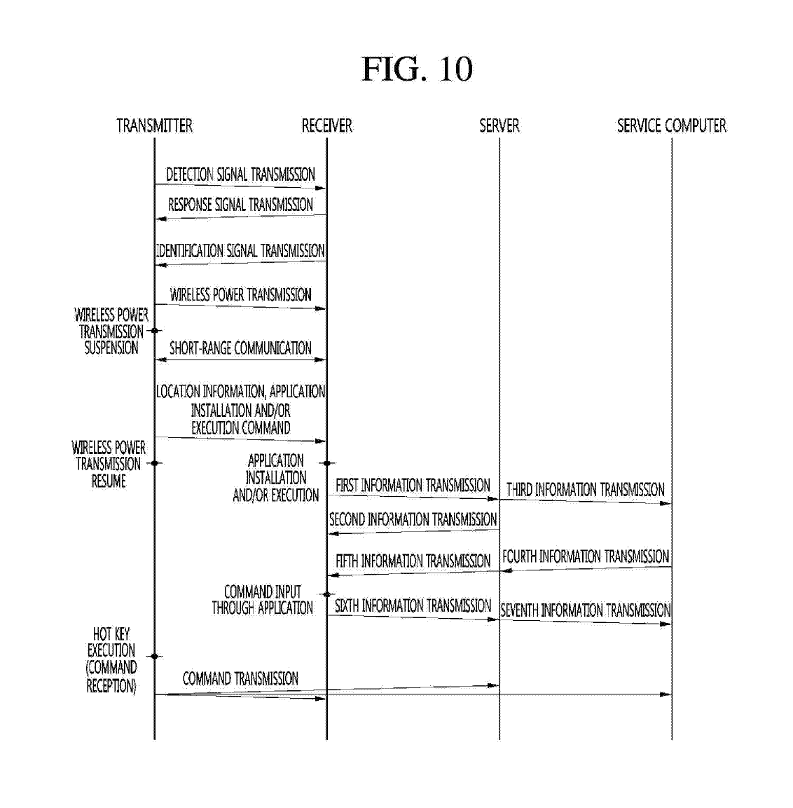

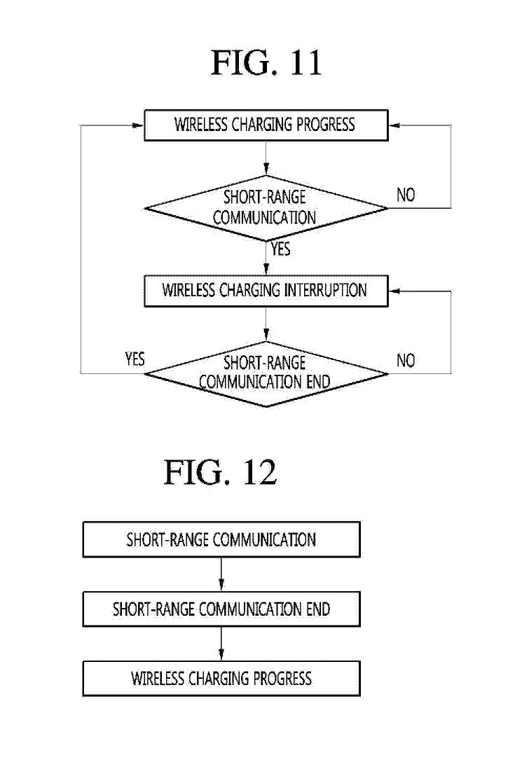

FIG. 9 is a diagram illustrating a wireless signal transmission/reception system, and FIG. 10 is a flowchart illustrating a method of driving a wireless signal transmission/reception system. And, FIGS. 11 and 12 are operational flowcharts showing the operation relationship between wireless charging and short-range communication.

Referring to FIGS. 9 and 10, a method of wirelessly transmitting a signal from the transmitter 1000 to the receiver 2000 includes an operation for transmitting a signal for detecting the receiver 2000, an operation for receiving an identification packet from the receiver 2000, an operation for transmitting wireless power to the receiver 2000, an operation for short-range communication with the receiver 2000, and an operation for performing installation and/or execution of the application of the receiver 2000 by performing short-range communication with the receiver 2000 and transmitting the location information of the transmitter 1000 to the receiver 2000. Also, when performing the short-range communication with the receiver 2000, the wireless power transmission may be suspended temporarily.

In addition, the wireless signal transmission method of the transmitter 1000 may also include an operation for communicating with at least one of the receiver 2000, the server 3000 and the service computer 4000 according to a command inputted through the hot key of the transmitter 1000. In this case, Bluetooth communication may be used as a communication method.

Also, as a method for the receiver 2000 to wirelessly transmit and receive signals, it may include an operation for transmitting a response signal to the detection signal from the transmitter 1000, an operation for transmitting an identification packet to the transmitter 1000, an operation for receiving wireless power from the transmitter 1000, an operation for performing short-range communication with the transmitter 1000, an operation for performing installation and/or execution of an application by performing short-range communication with the transmitter 1000 and receiving location information of the transmitter 1000, an operation for transmitting the first information to the server 3000 in response to the execution of the application, and an operation of receiving the second information from the server 3000 in response to the first information.

The first information may include at least one of user information, location information of the transmitter 1000, and battery charge status information of the receiver 2000, and the second information may include at least one of past usage information and recommendation information of the service computer 4000.

In addition, the server 3000 may transmit the third information to the service computer 4000. The third information may include user information received from the first information of the receiver 2000. The user information may be login information of a program installed in the service computer 4000.

Also, the third information may be battery charge status information received from the first information of the receiver 2000, and the battery charge status information is displayed on the service computer 4000 so that the user may confirm the information on the service computer 4000 in real time.

Also, the service computer 4000 may transmit the fourth information including the usage information of the program of the user's service computer to the server 3000, and the server 3000 receiving the fourth information may transmit the fifth information obtained by processing the fourth information to the receiver 2000 so that the user may confirm it in the receiver 2000.

In addition, sixth information including the user's command is transmitted to the server 3000 by receiving a user's command through the application executed in the receiver 2000, and the server 3000 transmits the seventh information obtained by processing the sixth information to the service computer 4000 to enable it to be a command for controlling the service computer 4000 if necessary, thereby controlling the service computer 4000. In addition, the sixth information may be information such as charging completion information or message information transmitted to a receiver. The sixth information may be transmitted to the service computer 4000 through the server 3000 in a seventh information form and displayed on the service computer 4000.

Specifically, the transmitter 1000 may include a transmission coil unit 1400 for transmitting a detection signal or wireless power of the receiver 2000, a short-range communication coil 1700 for communicating with the short-range communication coil 2700 of the receiver 2000 to install and/or execute the application of the receiver 2000 and to transmit location information, and a control unit 103 for receiving an identification packet from the receiver 2000.

The transmission coil of the transmission coil unit 1400 transmits wirelessly power to the receiver 2000, and the short-range communication coil of the short-range communication coil unit 1700 performs bidirectional communication with the short-range communication coil of the short-range communication coil unit 2700 of the receiver 2000 close to the short-range communication coil.

(1) The transmitter 1000 may transmit the wireless power to the receiver 2000 located in the charging area of the transmitter 1000 through the wireless charging operation described with reference to FIG. 5.

(2) And the short-range communication coil of the receiver 2000 is within a few cm of the short-range communication coil of the transmitter 1000, the transmitter 1000 and the receiver 2000 may perform bidirectional communication, and accordingly, the operation of the predetermined transmitter 1000 and the operation of the predetermined receiver 2000 may be executed.

(2-1) As an operation of the preset receiver 2000, it may be the automatic installation of a preset application in the receiver 2000 or the automatic execution of an installed application.

(2-2) In addition, the location information of the transmitter 1000 may be transmitted to the receiver 2000, and the application of the receiver 1000 related to the location information may be executed. That is, an application corresponding to the position of the transmitter 1000 may be executed.

(2-3) Further, the location information of the transmitter 1000 may be transmitted to the server 3000 in addition to the receiver 2000.

(2-4) Further, the identification information of the transmitter 1000 may be transmitted to the server 3000 other than the receiver 2000 or the receiver 2000.

The identification information may be a product number of the transmitter 1000 or a name or identification information of the transmitter 1000 set by the user.

(3) Wireless charging and bi-directional communication between short-range communication coils of transmitter and receiver 1000 and 2000 may be performed simultaneously.

(4) Moreover, in order to prevent damage to the short-range communication coil by wireless power, the wireless charging may be temporarily stopped during bidirectional communication between the short-range communication coils of the transmitter and the receiver 1000 and 2000.

(5) Furthermore, when the wireless charging is proceeded by the resonance method as shown in FIG. 11, wireless charging is performed through the wireless charging operation process described with reference to FIG. 5 in the receiver 2000 located in the charging area of the transmitter 1000. When the receiver 2000 is very close to the transmitter 1000 and the receiver 2000 is located in the communication area of the short-range communication coil of the transmitter 1000, wireless charging may be suspended, and short-range communication may be performed, and whether or not the wireless charging is resumed may be determined by determining whether the short-range communication is terminated.

(6) And, when conducting wireless charging using the induction method, as shown in FIG. 12, short-range communication is first performed between the transmitter 1000 and receivers 2000 very close to the transmitter 1000. After the short-range communication is completed, wireless charging may proceed. In a case where wireless charging is performed first, when short-range communication is performed after a predetermined time, the wireless charging may be temporarily stopped as shown in FIG. 11.

(7) Furthermore, when the transmitter 1000 and the receiver 2000 are close to each other, in order for a user to determine whether to perform at least one of wireless charging and short-range communication, a command may be received from a user through a touch method through a display window of the receiver 2000 or a button input of the receiver 2000 itself.

(8) Furthermore, for the user recognition, the transmitter 1000 may include a display, a sound device, and the like for informing of wireless charging and short-range communication performance. Furthermore, it is possible to display the charging state of the receiver 2000.

(9) In addition, the transmitter 1000 may include a Bluetooth device, and the transmitter may communicate with the receiver 2000, the server 3000, and the service computer 4000 through Bluetooth communication.

(10) Further, the transmitter 1000 may include a hot key, receive a command from a user via a hot key, and perform a predetermined operation. In this case, when the hot key is operated by the user as required, the transmitter 1000 may perform Bluetooth communication with the receiver 2000 or the other server 3000.

It also describes the operations of the receiver 2000, server 3000 and service computer 4000.

(1) The receiver 2000 may install and execute an application through short-range communication with the transmitter 1000.

(2) An application executed in the receiver 2000 may transmit various information of the transmitter 1000 and the receiver 2000 to the server 3000 by communicating with the server 3000. The various information may include user information, location information of the receiver 2000, location information of the transmitter 1000, and the charging state of the receiver 2000.

(3) The server 3000 receiving various information from the receiver 2000 communicates with the service computer 4000, and the device may display program execution and logins associated with the user of the receiver 2000 in the service computer 4000 and previous usage history information of the user. And, the service computer 4000 may also display the charge status information of the receiver 2000.

(4) In addition, the server 3000 transmits usage information and recommendation information of the user's past service computer 4000 to the receiver 2000 or the service computer 4000 so that the receiver 2000 or the service computer 4000 may display it, thereby confirming it by a user.

(5) Furthermore, through the touch input or the command reception button using the application of the receiver 2000 executed according to the short-range communication, the user may manipulate the use environment or the option of the program executed in the service computer 4000. In this case, the user's command is transmitted to the server 3000 through communication between the receiver 2000 and the server 3000. The server 3000 may transmit a user's command to the service computer 4000 so that the service computer 4000 may perform an operation according to the user's command.

(6) Furthermore, after executing the program, the service computer 4000 may transmit the actual motion of the user recognized through the program use information of the user or the camera installed in the service computer 4000 to the receiver 2000 through the server.

(7) In addition, the wireless charging completion information of the receiver 2000 and the status information of the receiver 2000 may be displayed on the service computer 4000 through the server 3000. In this case, the status information of the receiver 2000 may be various information such as a text message or a telephone transmitted from the outside to the receiver 2000.

<Golf Zone System>

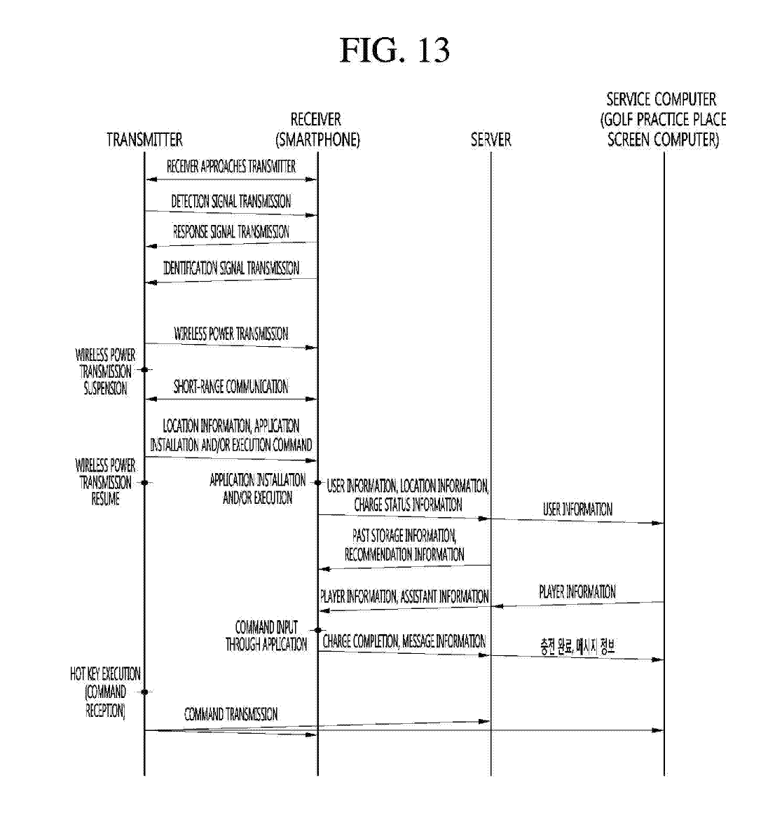

FIG. 13 is a flowchart of the operation of a golf zone system as one embodiment.

Referring to FIGS. 9 and 13, an example applied to a golf zone system will be described.

(1) In order to use the program of the charging and service computer 4000 of the receiver 2000, the user may bring the receiver 2000, which is a smartphone, to the transmitter 1000.

(2) In the transmitter 1000 and the receiver 2000 close to each other, the receiver 2000 may receive a command through short-range communication with the transmitter 1000, and may execute a predetermined program on the receiver 2000 or may be installed and executed in accordance with the received command. And, the location information of the transmitter 1000 may be provided to the receiver 2000 through the short-range communication. Here, the location information may be information on a room where a user is located, information on a seat where a user is located in the room, and the like.

(3) The application of the receiver 2000 executed in response to short-range communication may transmit user information, location information of the transmitter 1000, charge state information of the receiver 2000, and the like to the server 3000 automatically or by user's command.

(4) On the basis of the user information from the receiver 2000, the server 3000 may transmit a golf practice history or recommendation information to the receiver 2000 through the past service computer 4000 of the stored user. The server 3000 transmits user information from the receiver 2000 to the service computer 4000 so that the service computer 4000 may log in a golf practice related program or the like using the user information.

(5) The user may select the usage environment or options for golf practice through the application of the receiver 2000, and this information is transmitted to the service computer 4000 through the server 3000, and thus the service computer 4000 may be controlled through the receiver 2000.

(6) The service computer 4000 may transmit the current player information of the user or image or video information on the user's pose recognized in real time from the camera of the user to the receiver 2000 through the server 3000 and display it through an application running in the receiver 2000. In addition, the server 3000 may analyze real-time information on the user play received through the service computer 4000, and transmit information useful for play such as play-assistance information for improving user's play in addition to information on user play to the receiver 2000.

(7) Also, when a call is received or a message is received by the receiver 2000, as this information is transmitted to the service computer 4000 through the server 3000, the user may confirm such information through the display means of the service computer 4000 during the play.

(8) Further, the transmitter 1000 includes a hot key button, and transmits a specific command previously interlocked with the hot key button to one of the receiver 2000, the server 3000, and the service computer 4000 to perform an operation according to a predetermined command.

A method for transmitting and receiving a wireless signal of a transmitter according to an embodiment includes an operation for transmitting a signal for detecting a receiver, an operation for receiving an identification signal from the receiver, an operation for transmitting wireless power to the receiver, an operation for performing short-range communication with the receiver, and an operation for performing installation and/or execution of the application of the receiver by performing short-range communication with the receiver and transmitting location information of the transmitter to the receiver.

When the transmitter performs short-range communication with the receiver, the wireless power transmission may be interrupted. The transmitter may start the wireless power transmission after completing the short-range communication. The method for transmitting and receiving the wireless signal of the transmitter may further include an operation for communicating with the server or the receiver according to a command inputted through a hot key of the transmitter. The transmitter may perform Bluetooth communication through the hot key.

A method for transmitting and receiving a wireless signal of a receiver according to an embodiment of the present invention includes an operation for transmitting a response signal to the detection signal from the transmitter, an operation for transmitting an identification signal to the transmitter, an operation for receiving wireless power from the transmitter, an operation for performing short-range communication with the transmitter, an operation for performing installation and/or execution of an application by performing short-range communication with the transmitter and receiving location information of the transmitter, an operation for transmitting the first information to the server in response to the execution of the application, and an operation for receiving the second information from the server in response to the first information.

The first information may include at least one of user information, location information of a transmitter, and battery charge status information. The second information may include at least one of past usage information and recommendation information of the service computer. The user information may be login information of a program installed in the service computer. The battery charge status information may be displayed on the service computer. The receiver may input a command through the application and control the service computer through the server.

According to an embodiment, through a simple operation for bringing the receiver 2000 closer to the transmitter 1000, by allowing charging of the receiver 2000 and program login of the service computer 4000, the user convenience may be increased. The service computer 4000 may be controlled according to the operation of the application automatically executed by the receiver 2000, so that the convenience of control of the user's service computer 4000 may be improved.

While the present invention has been described with reference to the preferred embodiments thereof, those skilled in the art will understand that various modifications, additions and substitutions are possible, without departing from the scope and spirit of the invention as disclosed in the accompanying claims. Therefore, the technical scope of the present invention should not be limited to the contents described in the detailed description of the specification, but should be defined by the claims.

### INDUSTRIAL APPLICABILITY

The present invention may be used in the field of wireless power transmission and reception.

1. A transmitter for transmitting/receiving a wireless signal, the transmitter comprising:
a transmission coil configured to transmit a detection signal of a receiver or wireless power;
a short-range communication coil configured to communicate with a short-range communication coil of the receiver to allow an application of the receiver to be installed and/or executed and to transmit location information; and
a control unit configured to receive an identification signal from the receiver.

2. The transmitter of claim 1, wherein transmission of the wireless power is suspended temporarily during communication between the short-range communication coil of the receiver and a short-range communication coil of the transmitter.

3. The transmitter of claim 1, further comprising a hot key for receiving a command from the outside to communicate with the receiver and/or a server and transmit the command.

4. The transmitter of claim 1, wherein the hot key performs Bluetooth communication with the receiver and/or a server.

5. A receiver for transmitting/receiving a wireless signal, the receiver comprising:
a reception coil for receiving a detection signal or wireless power from a transmitter;
a short-range communication coil configured to communicate with a short-range communication coil of the transmitter to allow an application to be installed and/or executed and to receive location information of the transmitter; and
a control unit configured to transmit first information to a server in response to execution of the application and receive second information from the server in response to the first information.

6. The receiver of claim 5, wherein the first information comprises at least one of user information, location information of a transmitter, and battery charge status information,
wherein the second information comprises at least one of past usage information of a service computer and recommendation information.

7. The receiver of claim 6, wherein the user information is login information of a previously-installed program of the service computer.

8. The receiver of claim 6, wherein the battery charge status information is displayed on the service computer.

9. The receiver of claim 5, wherein a command is inputted through the application to control a service computer through the server

10. A method of driving a system for transmitting/receiving a wireless signal, the method comprising:
transmitting location information of a transmitter to a receiver and installing and/or executing an application of the receiver in response to short-range communication;
charging the receiver by wireless power from the transmitter;
transmitting first information to a server in response to execution of the application;
transmitting second information of the server to the receiver in response to the first information; and
transmitting the first information to a service computer.

11. The method of claim 10,
wherein the first information comprises at least one of user information, location information of a transmitter, and battery charge status information, and
wherein the second information comprises at least one of past usage information of a service computer and recommendation information.

12. The method of claim 11, wherein the battery charge status information is displayed on the service computer.

13. The method of claim 11, further comprising:
receiving a command through the application to control a service computer through the server.

14. The method of claim 11, wherein the user information is login information of a previously-installed program of the service computer.

15. The method of claim 10, further comprising:
transmitting user usage information on a program of the service computer to the receiver through the server.
